(19) United States
(12) Patent Application Publication
(10) Pub. No.: US 2008/0020724 A1
(43) Pub. Date: Jan. 24, 2008

(54) Establishing a data link between stacked cargo containers

(76) Inventor: John Robert Orrell, Advance, NC (US)

Correspondence Address: QUALCOMM INCORPORATED, 5775 MOREHOUSE DR., SAN DIEGO, CA, 92121, US

(21) Appl. No.: 11/490,423

(22) Filed: Jul. 19, 2006

(51) Int. Cl. H04B 1/18

(52) U.S. Cl. 455/187.1

(57) ABSTRACT

A container, a transponder, a method and a system are provided that are useful in determining the geographical position of a cargo container. In the event cargo containers are stacked one on top of another, those containers which lack a clear view of a satellite or terrestrial communications tower can transmit container ID information ultrasonically to containers that do have a clear view of a satellite or terrestrial communications tower. The containers having the clear views can transmit container ID information to remote networks using RF communications. The geographical positions of containers can be calculated locally or they can be calculated remotely by sending GPS data or trilateration data to a remote source for position determination.

### BACKGROUND

Containerized shipping revolutionized the shipping industry. Prior to its advent, the tasks of loading and unloading cargo of all shapes and sizes on and off ships, railroad cars and planes, were largely accomplished by the labor intensive, time consuming efforts of longshoremen employing nets and backbreaking labor. Containerized shipping reduced the time intensivity associated with loading and unloading cargo by trading a certain amount of labor intensivity for equipment intensivity. For instance, special cranes are used to lift standard sized cargo containers which provide a chassis for road transportation. Generally, containers are stacked during transit. The contents of each container can be quite diverse and its value can be great. Often containers are stacked one on top of another as shown in FIG. 1 which illustrates a stack 2 generally indicative of individual containers 4 stacked one on top of another. An ever present concern involves tracking containers. A particular 40′ container 4 loaded, for instance, on a ship and under other containers 4 can be difficult to find. Even these large standardized containers (measured in 20′ equivalent units (TEU)) are subject to being lost. Given the weeks journey that some containers travel, a container is subject to be unaccounted for during long stretches of time and much to the consternation and frustration of the shipper, carrier, owner and/receiver of the cargo contained within. In a long-range radio frequency identification approach to container tracking, transponders having transmitters are placed aboard or on containers for signaling via a radio frequency (RF) link using terrestrial or satellite communications. The RF transmitter transmits a coded signal when it receives a request from a monitoring or control point. The transponder output signal is tracked, so the position of the transponder and thus its associated cargo container can be constantly monitored. This generally only works well for the top container in a stack where the wireless link is unobstructed. Bulky containers and their contents generally attenuate a conventional RF signal when interposed between transmitter and receiver. This may prevent containers within a stack from being tracked A need therefore exists to solve this problem associated with tracking containers.

### BRIEF DESCRIPTION OF THE DRAWINGS

FIG. 1 is a front view of containers stacked one on top of another.

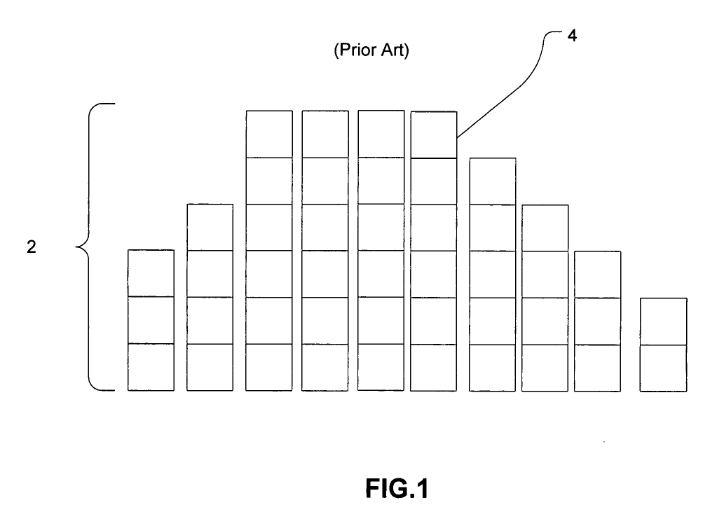

FIG. 2 illustrates a perspective view of a container equipped with a transponder.

FIG. 3 is a diagram depicting containers arranged in a stack amidst satellites and base transceiver stations.

FIG. 4 is a flowchart illustrating the operation of a transponder attached to a container.

FIG. 5 illustrates a block diagram of a transponder.

FIG. 6 illustrates a report printout of information which may be reflective of the contents a look-up table.

Applicable reference numerals have been carried forward.

### DETAILED DESCRIPTION

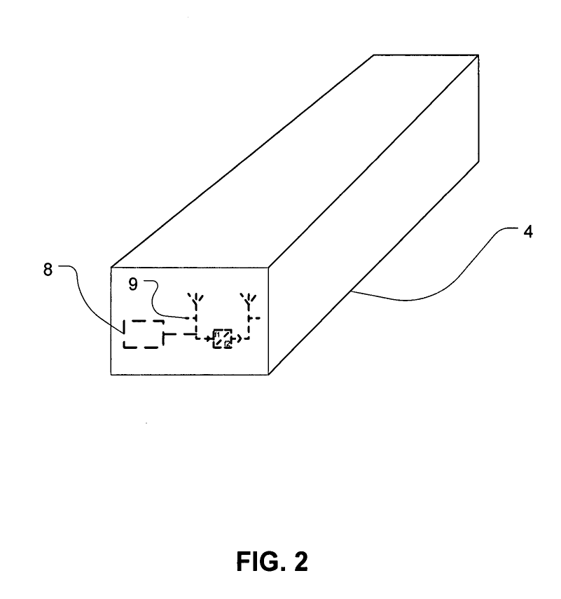

FIG. 2 illustrates cargo container 4 equipped with an active transponder 8. A transponder is a wireless communications that may receive and automatically respond to an incoming signal. Especially in the instance of satellite communications, transponders may operate over distances of several thousand miles. Active transponders can possess a sophistication that allow them to be used in communications satellites and on-board space vehicles. Incoming signals can be received over a range, or band, of frequencies, and the signals can be retransmitted on a different band. The receiver and transmitter frequencies may be pre-assigned. FIG. 2 illustrates an embodiment of transponder 8 which includes two antennas, one for transmission and the other for reception of figures. However, a single antenna can be used for both transmission and reception of signals. Further, in one embodiment, transponder 8 may optionally have a separate antenna section 9 housing various antenna components for transmissions and receptions discussed herein.

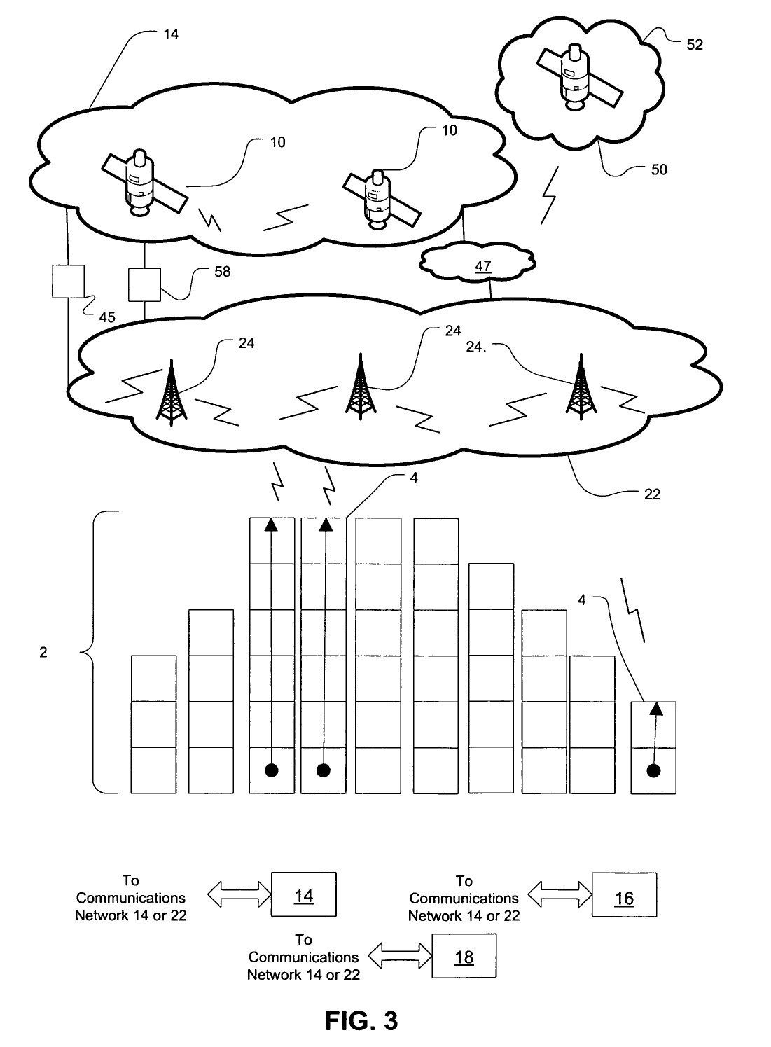

FIG. 3 is a diagram illustrating stack 2 of containers 4. Satellites 10 communicate with a transponder (not shown) in a container 4 in stack 2. Base transceiver station (BTS) 24, which forms part of a wireless terrestrial communication network 22, may also communicate with container 4 in stack 2. Transponder 8 first attempts wireless communications with a remote location from container 4 such as satellite 10, which forms part of a satellite network 14. In other embodiments, transponder 8 attempts communications to a BTS 24 in terrestrial communications network 22. Terrestrial communication network 22 may include, for instance, a digital cellular telephone network or a wireless data communication network, such as a cellular digital packet data (CDPD) network. Terrestrial communication network 22 may also include a code division multiple access (CDMA) system, a time division multiple access (TDMA) system or a frequency division multiple access (FDMA) system Regardless of the method of wireless communication used, contact may be made with shipper 14, consignee 16, or carrier 18 through transponder 8 of FIG. 2 for the purpose of coordinating and determining the location of goods located within container 4. Shipper 14 may comprise an individual or a business having goods to ship. Consignee 16 may comprises an entity, such as a business or an individual, capable of receiving goods. Carrier 18 comprises an entity for providing transportation services to ship or carry goods. This includes an operator of a ship, railroad car an airplane or jet plane.

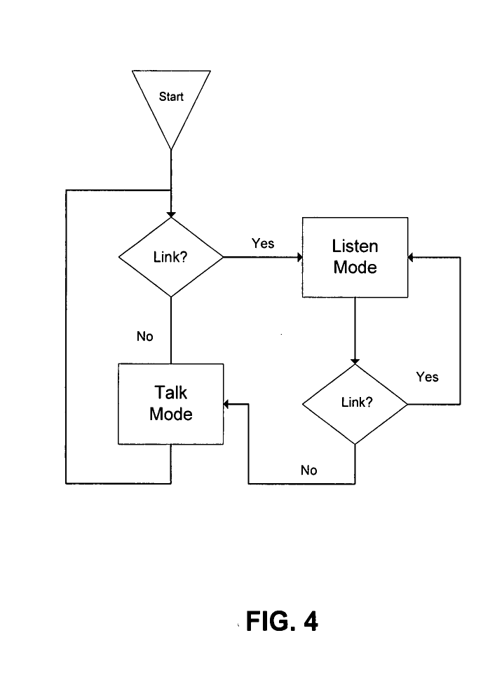

FIG. 4 is a flowchart illustrating the operation of transponder 8. With reference to FIGS. 2, 3 and 4, in one embodiment, transponder 8 establishes a data communications link (hereinafter referred to as “communications link”) in connection with transmitting a signal that is received by terrestrial communications network 22 or satellite communications network 14. When the communications link is established, transponder 8 places itself in a “listen” mode which allows it to receive requests and other information from a remote source. Listen mode may also entail scanning over a band including scanning to detect signals over a spread spectrum band of frequencies. This remote source may include a base transceiver station 24, a satellite 10 from terrestrial communications network 22 or satellite communications network 14, respectively. Transponder 8 also includes an ultrasonic transducer. Ultrasound generally refers to sound with frequencies above 20 kHz. Sound at these frequencies are beyond the upper limit of human hearing. Ultrasound has an advantage over many forms of communication signals in that it can penetrate dense objects such as steel. This property makes it useful in such applications as ultrasonic inspection of aircraft engine parts. This penetration property can be put to good use as described herein. Further, “listen” mode also allows transponder 8 to receive ultrasonic emissions from another transponder 8 connected to another container 4 within range of the transponder 8 in “listen” mode such as another container 4 in stack 2 of FIG. 3. An ultrasonic link may thereby be established. Ultrasound is only used for communication between containers in a given stack. In one preferred embodiment, this ultrasonic link between the containers 4 is bi-directional for conflict resolution in the event that two or more containers have RF visibility to the satellite or terrestrial system. Consequently, containers 4 may determine among themselves which transducer 8, connected to a particular container 4, establishes a communication link to terrestrial network 22 or (by relay) to satellite communications network 14. In one embodiment, a voting scheme weighs such strongest transponder 8 signal reception and which most transponder 8 battery power remaining. Communication link priority may be based on factors such as these. During communications link with the terrestrial or satellite communications networks (22,14), transponder 8 periodically takes itself out of listen mode and places itself in “talk” mode to transmit requested information, identification (ID) information, etc. to a base transceiver station 24 or for relay (indirect communications) to satellite 10. “Talk” mode transmissions to the remote source, such as networks 14 or 22, do not occur within the ultrasonic frequency range. As such transponder 8 has the capability of transmitting information to a remote communications network using conventional radio frequency (RF) digital wireless frequencies suitable for terrestrial communications network 22 or for relay to a satellite communications network 14. The more than one antenna embodiment of transponder 8 shown in FIG. 2 is useful toward this end. Transponder 8 periodically checks that the communications link is still in place given that container 4 is mobile and is subject to weak signal reception due to container positioning under an obstruction and possible container transfer to a different location including a different stack. If at some point a communications link cannot be established with the communications or satellite system (such as may be the case when container 4 is buried deep within stack 2 under a number of other containers) transponder 8 places itself in a “talk” mode which, in one embodiment, allows it to periodically emit identification (ID) information ultrasonically through a container 4 which is typically constructed from metal, e.g., steel. This emitted ID information may be received by a transponder 8 in another container 4 in or near stack 2 that has established a communications link with a terrestrial 22 or satellite communications network 14. With reference to FIG. 3, arrows are shown in stack 2 directed from a container 4 near the bottom of stack 2 to a container at the top of stack 2, indicative of the ultrasonic emissions to a container 4 near the top of stack 2, presumably having an unobstructed view of a satellite 10 or BTS 24. During one of the periodic talk modes experienced by the container 4 in connection with having established a communications link with a terrestrial communication network 22 or satellite communications network 14, ID information from transponder 8 and ID information received from other transponders, emitted ultrasonically that are within communication range of transponder 8, are transmitted to a satellite 10 or BTS 24. The periodic talk modes may be, for instance, spaced apart by a 10 second interval of time.

In other embodiments, transponder 8 can transmit information in addition to ID information to the remote source such as terrestrial communications network 22. Additionally, this information can be relayed to satellite communications network 14. For instance, with reference again to FIG. 2, the contents of a container 4 can be pre-coded and broadcast by a transducer 8. The coded contents information can be forwarded to the aforementioned satellite or terrestrial communication system. Further, in other embodiments, transponder 8 can respond to communications received from an outside source. For instance, a request for position or cargo information in the form of a request message can be received and responded to by transponder 8 through terrestrial communications network 22 or satellite communications network 14.

With reference to FIG. 3, in one embodiment, terrestrial communications network 22 receives transmitted information at a number of base transceiver stations 24. Using well known techniques of trilateration, the position of container 4 can be determined. Alternatively, using the pilot signals received from at least three BTSs 24, the position of container 4 can be calculated at transponder 8 in an embodiment wherein transponder 8 includes such processing capability. For this embodiment, transponder 8 transmits, to the remote source (networks 14 or 22) the common location calculated for all container ID transmissions. Given the accuracy of trilateration methods and the fact that containers may be dispersed though stack 2, containers can be reported within an accuracy of on average of between 75 to 100 feet. Alternatively, trilateration data may be relayed to the remote source for position determination of a container calculated at the remote source.

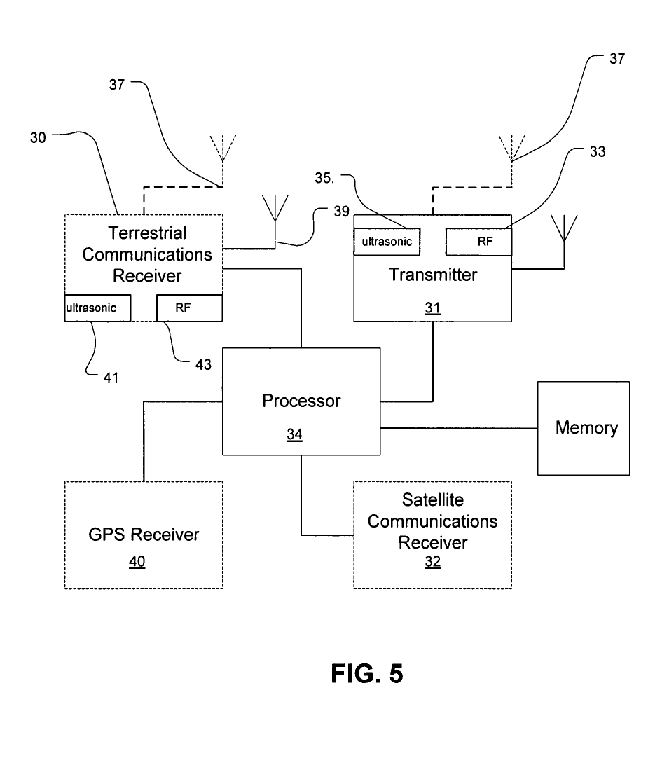

Transponder 8 as described herein is shown in the block diagram illustrated in FIG. 5. In one embodiment, transponder 8 includes transmitter 31 having an RF transmitter 33 and an ultrasonic transmitter 35. In some embodiments transponder 8 includes RF antenna 37 for terrestrial communications and for satellite communications via a relay. Transponder 8 may also have an antenna 39 for communications on ultrasonic frequencies. Terrestrial communications receiver 30 or satellite communications receiver 32 are connected to processor 34. Terrestrial communications receiver may include ultrasonic receiver 41 and RF receiver 43. However, some embodiments may include either terrestrial communication receiver 30 or satellite communication receiver 32, but not both receivers 30 and 32. Alternatively, some embodiments may include both terrestrial communication receiver 30 and satellite communication receiver 32. Processor 34 is programmed to implement the communication modes (e.g., talk mode and receive mode) of transponder 8. Storage of data and programming may be resident in memory 36 connected to processor 34. In another embodiment, transponder 8 includes a global positioning system (GPS) receiver 40 used in connection with determining the geographical position of an associated container 4. GPS receiver 40 receives GPS signals from a GPS satellite network 50 for location determination which it forwards to processor 34 for either determination of container positioning or for forwarding of GPS information to a remote location for processing and position determination of a container 4.

In connection with GPS receiver 40 being locked on to the signal of at least three satellites 10 (shown in FIG. 3), the latitude and longitude position of the GPS receiver and its associated container 4 can be determined since the position of GPS receiver 40 can be assumed to be that of an associated container 4. Further, the movement of GPS receiver 40 and thus its associated container 4 can be tracked as well. The three dimensional position, including latitude and longitude as well as altitude, of a container can be determined when container 4 has an unobstructed view of four or more satellites.

In yet another embodiment, with reference to FIGS. 3 and 5, transponder 8 forwards the received GPS signals to a remote location, such as a remote server 45, using satellite network 10 or terrestrial network 22 for calculation of the position of a container 4. Remote server 45 may for example be accessed using Transmission Control Protocol/Internet Protocol TCP/IP or using asynchronous transport mode (ATM) network 47. In another embodiment, BTS 24 which may relay GPS data from transponder 8 to a network management center (NMC) 58 for computation and tracking of containers.

With reference again to FIG. 3, shipper 14, consignee 16, or carrier 18 may request information concerning shipped goods or articles through NMC 58. NMC 58 may possess an electronic look-up table matching a specific good or article with a container. With reference to FIGS. 2 and 3, NMC 58 may receive sought after ID information from a transponder 8 in connection with the transponder 8 being in a “talk” mode and broadcasting its own associated container ID or the ID of another container 4 in stack 2.

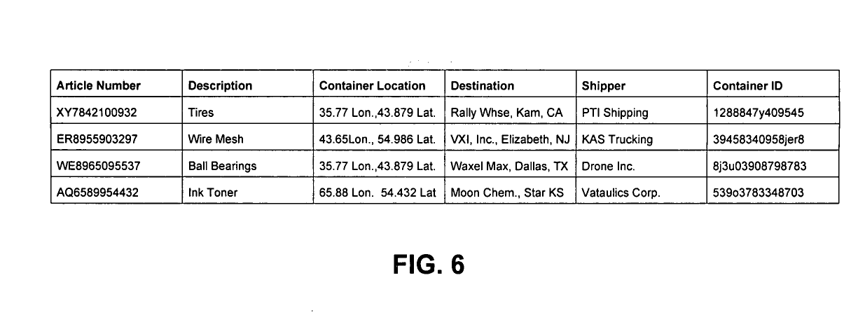

FIG. 6 illustrates a report printout of information which may be reflective of the contents of the aforementioned look-up table. Table 6 notes look up information that may include the article number, the article description, the container location in longitude and latitude, the destination of the article or good, the shipper and the container ID. The look-up table information can be updated to provide a ready reference for information concerning shipped items. Ordinarily, items in containers can remain there for long periods of time. The view of stacked containers in desolate looking places is a common view throughout the world. Losing track of a container and its contents for periods of time would continue to be a common occurrence until now, but for the foregoing.

Although the invention herein has been described with reference to particular embodiments, it is to be understood that these embodiments are merely illustrative of the principles and applications of the present invention. For instance, although transmitters and receivers are discussed and shown throughout, it is contemplated that a receiver and transmitter can be combined as a single unit in a transceiver. It is therefore to be understood that numerous modifications may be made to the illustrative embodiments and that other arrangements may be devised without departing from the spirit and scope of the present invention as defined by the appended claims.

What is claimed is:

1. A container including:
an attached transponder including a transmitter and a receiver, said receiver being operable to receive ID information from other transponders attached to other containers, said transmitter being operable to transmit ID information of said container and ID information of said other containers.

2. A container as recited in claim 1 wherein said transponder includes a transducer for ultrasonic communications among other containers and an RF antenna for communications with a remote source.

3. A container as recited in claim 2 wherein said remote source consists of a terrestrial communications network, a satellite communications network and a combination thereof.

4. A container as recited in claim 1 wherein said receiver includes an ultrasonic communications receiver and a radio frequency receiver.

5. A container as recited in claim 1 wherein said transmitter includes an ultrasonic communications transmitter and a radio frequency transmitter.

6. A transponder for use with a container including;
a receiver;
a transmitter; and
a processor, said processor being programmed to cause said transmitter to emit an ID of an associated container to which said transponder is attached, in event a communications link with a remote communications network fails to be established, said processor being further programmed to cause, while said transponder has established said communications link, said receiver to receive communications from said remote communications network and ID information emitted from other transponders of other containers to which said other transponders are associated and attached, said processor being additionally programmed to cause said transmitter to transmit the ID of its associated container and the IDs of said other containers associated with said other transponders unable to establish a communications link with said communications network.

7. A transponder as recited in claim 6 which includes a transducer for ultrasonic communications among other containers and an RF antenna for communications with a remote communications network.

8. A transponder as recited in claim 7 wherein said remote communications network consists of a terrestrial communications network, a satellite communications network and a combination thereof.

9. A transponder as recited in claim 6 wherein said receiver includes an ultrasonic communications receiver and a radio frequency receiver.

10. A transponder as recited in claim 6 wherein said transmitter includes an ultrasonic communications transmitter and a radio frequency transmitter.

11. A method of tracking containers comprising:
emitting container ID information of an associated container in event a communications link with a remote communication network fails to be established;
receiving, during the establishment of said communications link, communications from said communications system and from a plurality of other transponders which emit ID information of other associated containers to which the other transponders are attached; and
transmitting the container ID information of said associated container and the ID information of said other associated containers received from said other transponders that are unable to establish a communications link with said communications network.

12. A method as recited in claim 11 wherein emitting container ID information occurs using ultrasonic frequencies.

13. A method as recited in claim 11 wherein transmitting said container information comprising transmitting said container information to a remote communications network via RF communication.

14. A method as recited in claim 11 further comprising receiving GPS data and calculating geographical position of said containers using said GPS data.

15. A method as recited in claim 14 wherein said GPS data is forwarded to a remote location for calculation geographical position of said containers.

16. A method as recited in claim 11 further comprising receiving at least three pilot signals each from three terrestrial communication sources and calculating geographical position of said containers.

17. A method as recited in claim 16 wherein said terrestrial communication sources are base transceiver stations.

18. A method as recited in claim 11 further comprising receiving trilateration data and calculating geographical position of said containers using said trilateration data.

19. A system for tracking containers comprising:
at least one communications network remote from a stack of containers; and
a plurality of transponders, each transponder being attached to an associated container in said stack, ones of said transponders being able to receive container ID information and transmit container ID information directly to said at least one communications network in event of being able to establish a communications link with said communications network, those transponders unable to establish a communications link with said communications network being operable to send associated container ID information by emitting ID information for reception by said ones of said transponders being able to establish said communications link.

20. A system for tracking containers as recited in claim 19 wherein each of said plurality of transponders includes a GPS receiver for receiver GPS data for use in tracking said containers.

21. A system as recited in claim 19 wherein emitting ID information for reception by said ones of said transponders being able to establish said communications link is accomplished using ultrasonic emissions.

22. A system as recited in claim 19 wherein each transponder includes a first antenna for ultrasonic communications among other containers and a second antenna for communications with a remote source.

23. A system as recited in claim 19 wherein said at least one communications network consists of a terrestrial communications network, a satellite communications network and a combination thereof.

24. A system as recited in claim 19 wherein each transponder includes a receiver for receiving ultrasonic communications.

25. A system as recited in claim 19 wherein each transponder includes a receiver for receiving radio frequency communications including a request message through said at least one communications network.

26. A system as recited in claim 25 wherein said request message consists of a request for container position information or container contents.
